(19) United States
(12) Patent Application Publication
(10) Pub. No.: US 2006/0290723 A1
(43) Pub. Date: Dec. 28, 2006

(54) Method and apparatus to detect ink level

(75) Inventor: Jin-wook Jeong, Yongin-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/471,486

(22) Filed: Jun. 21, 2006

(30) Foreign Application Priority Data
Jun. 24, 2005 (KR) 2005-55126

(51) Int. Cl. B41J 2/195

(52) U.S. Cl. 347/7

(57) ABSTRACT

A method and apparatus to detect an ink level includes an ink storage unit to store ink, an ink level detection unit to detect an initial ink level of the ink storage unit using a sensor and to output the detected result, a calculation unit to calculate a volume of an ejected unit ink droplet in a predetermined ink volume range in response to the result output from the ink level detection unit, and an ink level computation unit to compute the ink level of the ink storage unit using the calculated volume of the ejected unit ink droplet.

### CROSS-REFERENCE TO RELATED APPLICATIONS

This application claims priority under 35 U.S.C. §119(a) from Korean Patent Application No. 10-2005-0055126, filed on Jun. 24, 2005, in the Korean Intellectual Property Office, the disclosure of which is incorporated herein in its entirety by reference.

### BACKGROUND OF THE INVENTION

1. Field of the Invention

The present general inventive concept relates to an ink-jet image forming apparatus, such as a printer, a facsimile, or a multi-function product (MFP), which prints an image on a printing medium by ejecting ink, and more particularly, to a method and apparatus to accurately detect a stored ink level using a sensor and a count of the number of ejected droplets.

2. Description of the Related Art

In an ink-jet image forming apparatus, conventional methods of detecting a level of stored ink use an ink level sensor or count the number of ejected ink droplets.

According to the conventional method of using an ink level sensor, the stored ink level is detected by sensors, such as an optical sensor, a weight sensor, and a magnetic sensor.

According to the conventional method of counting the number of ejected ink droplets, the number of droplets ejected from nozzles of the ink-jet image forming apparatus is counted to calculate the stored ink level.

In the conventional method of detecting the ink level using an ink level sensor, it is difficult to detect the ink level exactly because the ink level changes in an analog way, and the exact detection of the ink level becomes more complex at low ink levels, due to a structure of the sensor.

FIG. 1 is a graph illustrating a relationship between a dot diameter of ink droplets and a temperature at an ink head. Referring to FIG. 1, it can be seen that the dot diameter of the ink droplets increases (and thus a viscosity of ink decreases) as the temperature at the ink head increases, indicating that temperature changes have a significant effect on a volume per ink droplet ejected from nozzles of the ink head. A maximum variation of the dot diameter of the ink droplets can be about 20%. When an ink level is calculated by counting the number of ejected ink droplets, it is difficult to calculate an exact ink level because the volume per ink droplet varies significantly with changes in the temperature at the ink head during printing. To solve this, an ink level margin is usually provided, but this wastes ink. In addition, if a container of ink is refilled, it is impossible to detect the ink level.

### SUMMARY OF THE INVENTION

The present general inventive concept provides a method and apparatus to more accurately detect an ink level using a sensor to detect an ink level and a count of the number of ejected ink droplets.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an apparatus to detect an ink volume in an image forming apparatus, including an ink storage unit to store ink, an ink level detection unit to detect an ink level of the ink of the ink storage unit using a sensor and to output the detected result, an calculation unit to calculate a volume of an ejected unit ink droplet in a predetermined ink volume range using the result output from the ink level detection unit, and an ink level computation unit to compute an ink volume remaining in the ink storage unit using the calculated volume of the ejected unit ink droplet.

The ink level detection unit may detect the ink level of the ink storage unit when the ink level corresponds to a predetermined maximum ink level or a predetermined minimum ink level and output the detected result.

The calculation unit may include a first counting unit to count the number of ejected ink droplets in the predetermined ink volume range between the maximum ink level and the minimum ink level in response to the result output from the ink level detection unit, and a unit droplet level calculation unit to calculate the volume of the ejected unit ink droplet using the count number.

The unit droplet level calculation unit may calculate the volume of the ejected unit ink droplet using the following mathematical expression:
Volₚₑᵣ=(Vol_{high}−Vol_{low})/Num

where Volₚₑᵣ denotes the volume of the ejected unit ink droplet, Vol_{high} denotes the maximum ink level, Vol_{low} denotes the minimum ink level, and Num denotes the number of ink droplets counted by the first counting unit of the calculation unit.

The ink level computation unit may include a second counting unit to count the number of droplets ejected after the minimum ink level is detected, and an ink level calculation unit to calculate the ink volume of the ink storage unit based on the number of counted ink droplets using the calculated volume of the ejected unit ink droplet.

The ink level calculation unit may calculate the ink volume of the ink storage unit using the following mathematical expression:
Volᵢₙₖ=Vol_{low}−(Volₚₑᵣ*Num_{low})

where Volᵢₙₖ denotes the ink level of the ink storage unit, Vol_{low} denotes the minimum ink level, Volₚₑᵣ denotes the volume of the ejected unit ink droplet, and Num_{low} denotes the number of ink droplets counted by the second counting unit of the ink level computation unit.

The ink level detection unit may determine the minimum ink level to be 5% of the maximum amount of ink that can be stored in the ink storage unit.

The ink level detecting apparatus may further include a unit droplet level storage unit to store the volume of the ejected unit ink droplet calculated by the calculation unit.

The calculation unit may update the volume of the ejected unit ink droplet in a second predetermined ink volume range between the maximum ink level and the minimum ink level when the ink storage unit is refilled with ink to a level greater than the maximum ink level.

The ink level computation unit may read the volume of the unit ink droplet stored in the unit droplet level storage unit after the minimum ink level is detected and compute the ink level of the ink storage unit using the read volume of the unit ink droplet.

The ink level detecting apparatus may further include an ink shortage display unit to indicate that the ink storage unit is empty when the calculated ink level is less than a predetermined critical value.

The foregoing and/or other aspects and utilities of the present general inventive concept may also be achieved by providing a method of detecting an ink volume in an image forming apparatus, the method including detecting an ink level of an ink storage unit using a sensor, calculating a volume of an ejected unit ink droplet in a predetermined range of the ink level using the detected result, and computing an ink volume of the ink storage unit using the calculated volume of the ejected unit ink droplet.

The detecting of the ink level of the ink storage unit can include detecting the ink level of the ink storage unit at a maximum ink level or a minimum ink level.

The calculating of the volume of the ejected unit ink droplet may include counting the number of ejected ink droplets in the predetermined ink volume range between the maximum ink level and the minimum ink level, and calculating the volume of the ejected unit ink droplet based on the counted number.

The calculating of the volume of the ejected unit ink droplet may include calculating the volume of the ejected unit ink droplet using the following mathematical expression:
Volₚₑᵣ=(Vol_{high}−Vol_{low})/Num

where Volₚₑᵣ denotes the volume of the ejected unit ink droplet, Vol_{high} denotes the maximum ink level, Vol_{low} denotes the minimum ink level, and Num denotes the number of counted droplets.

The computing of the ink volume of the ink storage unit may include counting the number of ink droplets that are ejected after the minimum ink level is detected, and calculating the ink volume of the ink storage unit based on the number of counted droplets using the calculated volume of the ejected unit ink droplet.

The calculating of the ink volume of the ink storage unit may include calculating the ink volume using the following mathematical expression:
Volᵢₙₖ=Vol_{low}−(Volₚₑᵣ*Num_{low})

where Volᵢₙₖ denotes the volume of the stored ink, Vol_{low} denotes the minimum ink level, Volₚₑᵣ denotes the volume of the calculated unit ink droplet, and Num_{low} denotes the number of counted droplets.

The detecting of the ink level of the ink storage unit may include detecting the minimum ink level when a remaining amount of ink is 5% of the maximum amount of ink that can be stored in the ink storage unit.

The ink level detecting method may comprise storing the calculated volume of the ejected unit ink droplet.

The calculating of the volume of an ejected unit ink droplet may include updating the volume of the ejected unit ink droplet in a second predetermined volume range between the maximum ink level and the minimum ink level when the ink storage unit is refilled with ink to a level greater than the maximum ink level.

The computing of the ink volume of the ink storage unit may include reading the volume of the ejected unit ink droplet stored in the unit droplet level storage unit and computing the ink volume of the ink storage unit using the read volume of the ejected unit ink droplet.

The method may further include indicating that the ink storage unit is empty when the computed ink volume is less than a predetermined critical value.

The foregoing and/or other aspects and utilities of the present general inventive concept may also be achieved by providing a computer-readable medium having embodied thereon a computer program for performing a method of detecting an ink volume in an image forming apparatus, the method including detecting an ink level of an ink storage unit using a sensor, calculating a volume of an ejected unit ink droplet in a predetermined range of the ink level using the detected result, and computing an ink volume of the ink storage unit using the calculated volume of the ejected unit ink droplet.

The foregoing and/or other aspects and utilities of the present general inventive concept may also be achieved by providing an apparatus to determine an ink level of an image forming apparatus, the apparatus including an ink level detecting unit to detect a first amount of ink contained in an ink storage unit, and a unit to calculate a second amount of ink remaining in the ink storage unit using a first number of ink droplets consumed from the first amount of ink and a second number of ink droplets consumed after the first amount of in has been consumed.

The first amount of ink may include an amount of ink between a first level and a second level of the ink, and the second amount may include an amount of ink less than the second level of ink. The unit may include a calculation unit to generate a volume of the unit ink droplet according to the detected amount and the first number of ink droplets consumed from the detected amount, and an ink level computation unit to generate the second amount of ink according to the second number of ink droplets. The ink level detecting unit may detect a third amount of ink which is refilled in the ink storage unit after at least a portion of the first amount corresponding to the first number of ink droplets and a second amount corresponding to the second number of ink droplets has been consumed, and the unit may calculate a fourth amount of ink remaining in the ink storage unit using a third number of ink droplets consumed from the third amount of ink and a fourth number of ink droplets consumed after the third amount of ink has been consumed.

The foregoing and/or other aspects and utilities of the present general inventive concept may also be achieved by providing an apparatus to detect an ink level of an ink storage unit of an image forming apparatus, the apparatus including an ink level detecting unit to detect a first level and a second level of ink, and a unit to generate a volume of a unit ink droplet according to a first number of ink droplets and a first amount of the ink between the first level and the second level, and to generate a second amount of ink consumed when the ink is lower than the second level using the volume of the unit ink droplet and a second number of ink droplets consumed from the second amount of ink. The unit may generate a third amount of ink remaining in the ink storage unit using the first amount and the second amount.

The foregoing and/or other aspects and utilities of the present general inventive concept may also be achieved by providing an apparatus to detect a remaining ink in an ink storage unit of an image forming apparatus, the apparatus including a unit to generate a remaining ink of the ink storage unit according to a first number of ink droplets from a first amount of ink and a second number of ink droplets from a second amount of ink.

The foregoing and/or other aspects and utilities of the present general inventive concept may also be achieved by providing an apparatus to detect a remaining ink in an ink storage unit of an image forming apparatus, the apparatus including a unit to generate a signal representing a remaining ink in the ink storage unit using a unit droplet volume of a first amount of ink and a number of ink droplets of a second amount of ink.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph illustrating a relationship between a dot diameter of ink droplets and a temperature at an ink head;

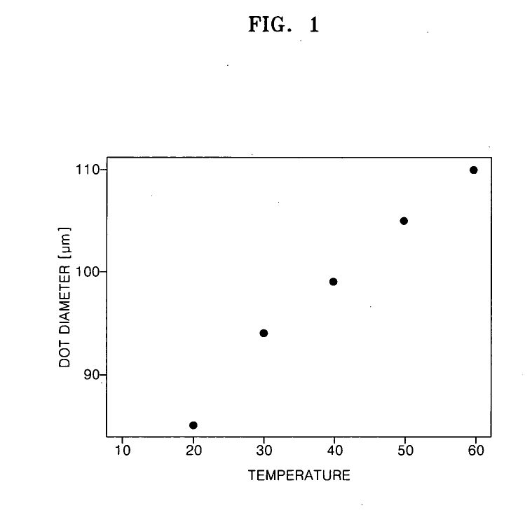

FIG. 2 is a block diagram illustrating an apparatus to detect an ink level volume according to an embodiment of the present general inventive concept;

FIG. 3 is a flowchart illustrating a method of detecting an ink level according to an embodiment of the present general inventive concept; and

FIG. 4 is a flowchart illustrating a method of detecting an ink level according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

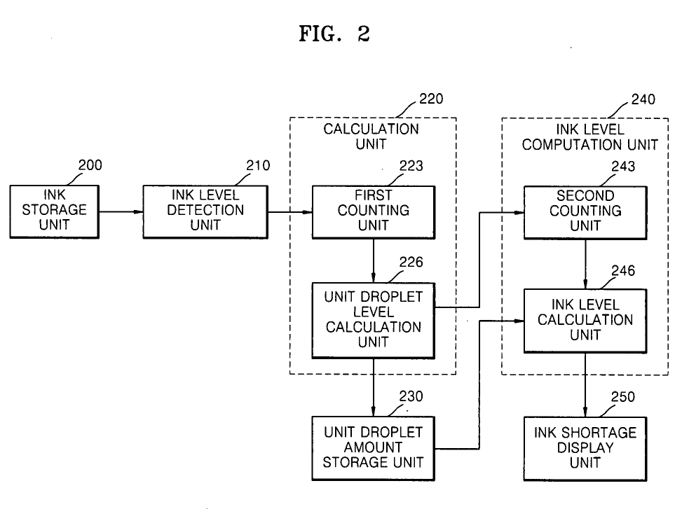

FIG. 2 is a block diagram illustrating an apparatus to detect an ink level according to an embodiment of the present general inventive concept. The apparatus to detect the ink level can include an ink storage unit 200, an ink level detection unit 210, a calculation unit 220, a unit droplet amount storage unit 230, an ink level computation unit 240, and an ink shortage display unit 250. The calculation unit 220 can include a first counting unit 223 and a unit droplet level calculation unit 226. The ink level computation unit 240 can include a second counting unit 243 and an ink level calculation unit 246.

The ink storage unit 200 can store a predetermined amount of ink that is to be ejected onto a printing medium. For example, the ink storage unit 200 may be an ink tank included in an ink cartridge.

The ink level detection unit 210 can use a sensor to detect the level of ink stored in the ink storage unit 200 and can output the detected result (detected ink level) to the first counting unit 223. Examples of the sensor used in the ink level detection unit 210 include, but are not limited to, an optical sensor to sense the ink level based on an amount of reflected light when light is radiated onto the ink, a weight sensor to sense the ink level by measuring a weight of the ink, and a magnetic sensor to sense the ink level using a magnetic field.

The image forming apparatus containing the apparatus to detect the ink level can set two or more ink level values to calculate a volume (amount) of a unit droplet ejected from a unit nozzle of an inkjet head unit of the image forming apparatus. The unit nozzle may include a single nozzle or a group of nozzles, and the unit droplet may be a single ink droplet ejected from a single nozzle or a group of ink droplets ejected from the group of nozzles. These values are maximum and minimum amounts of remaining ink, and are referred to as the maximum ink level and the minimum ink level. The apparatus may calculate a volume per ink droplet ejected from a nozzle of the inkjet head unit to form an image.

The maximum ink level can be determined to be 85% of the maximum volume of ink that can be stored in the ink storage unit 200. In addition, the minimum ink level can be determined to be 5% of the maximum volume of ink that can be stored in the ink storage unit 200. If the ink level in the ink storage unit 200 is less than 5% of the maximum volume of ink that can be stored in the ink storage unit 200, detection of the exact ink level using the sensor of the ink level detection unit 210 may be difficult when taking a system structure into consideration. However, according to the sensor type, sensing method, and system structure, the maximum ink level can be 70% or 60% of the maximum volume of ink that can be stored in the ink storage unit 200, and the minimum ink level can be 30% or 10% of the maximum volume of ink that can be stored in the ink storage unit 200, or other suitable values. If a sensing ability of the sensor is low, the minimum ink level can be set high, so that the maximum ink level and the minimum ink level are, for example, 90% and 60% of the maximum volume of ink that can be stored in the ink storage unit 200, respectively. The ink storage unit 200 can determine a possible ink storage level by taking 90% of the maximum volume of ink as a reference level.

The ink level detection unit 210 can detect the volume of the ink stored in the ink storage unit 200, compare the volume of the ink with the maximum ink level volume and/or the minimum ink level volume, and output the detected result to the first counting unit 223.

The calculation unit 220 can calculate a volume per ink droplet (a volume or amount of a unit ink droplet) ejected when a remaining ink volume or amount is in a specific ink volume using the output result of the ink level detection unit 210. As illustrated in FIG. 2, the calculation unit 220 can include the first counting unit 223 and the unit droplet level calculation unit 226.

The first counting unit 223 counts the number of ink droplet ejected from nozzles of the image forming apparatus by adding the number of ejected ink droplets after the maximum ink level is detected and until the minimum ink level is detected by the ink level detection unit 210. The number of ejected ink droplets denotes the total number of dots dispersed through all nozzles included in the image forming apparatus.

The unit droplet level calculation unit 226 calculates the volume of unit droplet ejected through the nozzles using the count total from the first counting unit 223, using the following mathematical expression 1:
Volₚₑᵣ=(Vol_{high}−Vol_{low})/Num 1,

where Volₚₑᵣ denotes the volume of the ejected unit ink droplet, Vol_{high} denotes the maximum ink level, Vol_{low} denotes the minimum ink level, and Num denotes the number of ink droplets counted by the first counting unit 223.

As an example, if the maximum volume of ink that can be stored in the ink storage unit 200 is 60 ml, the maximum ink level is 85% of the maximum volume of 60 ml, the minimum ink level is 5% of the maximum volume of 60 ml, and the number of droplets counted by the first counting unit 223 is 20,000,000, then the unit droplet level calculation unit 226 calculates the volume of the unit ink droplet ejected from the nozzles to be (60 ml*85%−60 ml*5%)/20,000,000 droplets=0.0000024 ml/droplet=2.4 nl/droplet.

The unit droplet amount storage unit 230 stores the volume of the unit ink droplet calculated by the unit droplet level calculation unit 226. The volume of the unit droplet may be an average volume of each of the droplets.

The ink level computation unit 240 computes the level of ink stored in the ink storage unit 200 using the volume of the unit ink droplet calculated by the unit droplet level calculation unit 226. As illustrated in FIG. 2, the ink level computation unit 240 can include the second counting unit 243 and the ink level calculation unit 246.

The second counting unit 243 counts the number of droplets ejected from all the nozzles included in the image forming apparatus after the minimum ink level is detected by the ink level detection unit 210.

The ink level calculation unit 246 calculates the level of ink stored in the ink storage unit 200 after the minimum ink level is detected by the ink level detection unit 210 based on the number of droplets counted by the second counting unit 243, using the volume of the unit ink droplet calculated by the unit droplet level calculation unit 226, using the following mathematical expression 2:
Volᵢₙₖ=Vol_{low}−(Volₚₑᵣ*Num_{low}) 2,

where Volᵢₙₖ denotes the volume of ink remaining in the ink storage unit 200, Vol_{low} denotes the minimum ink level amount, Volₚₑᵣ denotes the volume per ink droplet calculated by the unit droplet level calculation unit 226, and Num_{low} denotes the number of droplets counted by the second counting unit 243.

As an example, if the maximum of ink that can be stored in the ink storage unit 200 is 60 ml, the minimum ink level is 5% of this 60 ml, the number of droplets counted by the second counting unit 243 is x, and the volume per ink droplet is calculated to be 2.4 nl/droplet, then the ink level calculation unit 246 calculates the level of ink stored in the ink storage unit 200 to be (60 ml*5%)−(2.4 nl/droplet*x droplets), based on the number of the droplets counted by the second counting unit 243.

According to the present embodiment, when the ink volume in the ink storage unit 200 is greater than the minimum ink level, the ink level detection unit 210 detects the ink level using the sensor of the ink level detection unit 210. When the ink volume in the ink storage unit 200 is less than the minimum ink level, the ink level is calculated based on the number of unit droplets calculated by the unit droplet level calculation unit 226.

The ink shortage display unit 250 indicates that the ink level is “low” when the ink volume in the ink storage unit 200 is at the minimum ink level, and indicates that the ink storage unit 200 is “empty” when the ink volume in the ink storage unit 200 is at or below a predetermined critical value. Examples of a display unit of the ink shortage display unit 250 include, but are not limited to, an LCD panel provided in the image forming apparatus and a dialog box on a host device. The predetermined critical value can be an ink volume level at which printing is impaired due to an insufficient volume of ink.

As an example, if the maximum volume of ink that can be stored in the ink storage unit 200 is 60 ml and if the critical value is 3% of the maximum volume of ink that can be stored in the ink storage unit 200, the critical value can be represented as 60 ml*3%=1.8 ml. In particular, in this example, when the remaining ink volume in the ink storage unit 200, represented by the mathematical expression 2, is at or below 1.8 ml, the ink shortage display unit 250 indicates that the ink storage unit 200 is empty. Specifically, in this example, when the number of ejected unit droplets is 500,000 (or greater), the ink level volume of the ink storage unit 200 is (60 ml*5%)−(2.4 ni/droplet*500,000 droplets)=1.8 (or less). As a result, the ink shortage display unit 250 indicates that the ink storage unit 200 is empty. It is also possible for the ink shortage display unit to generate a warning signal to indicate “empty” when the number of ink droplets is greater than 500,000 droplets according to the above calculation based on the critical value of 1.8 ml.

When the volume of ink of the ink storage unit 200 is detected by the sensor to be in a range between the maximum ink level and the minimum ink level, or is detected by the sensor to be less than the minimum level, ink can be refilled into the ink storage unit 200 to a volume that is greater than the maximum ink level. In this case, where ink is refilled into the ink storage unit 200 without replacing the ink storage unit 200, the calculation unit 220 updates the amount (volume) of ejected unit ink droplet calculation by using the difference in volume between the maximum and minimum ink level volumes along with a count of the number of ejected ink droplets after the maximum ink level volume is detected and until the minimum ink level volume is detected.

In addition, when the volume of ink of the ink storage unit 200 is less than the minimum ink level, ink can be refilled into the ink storage unit 200 to a volume in a range between the maximum ink level and the minimum ink level. In this case, where ink is refilled into the ink storage unit 200 without replacing the ink storage unit 200, the ink level calculation unit 246 reads the volume of the unit ink droplet stored in the unit droplet level storage unit 230 and computes the ink level of the ink storage unit 200 using the volume of the unit ink droplet.

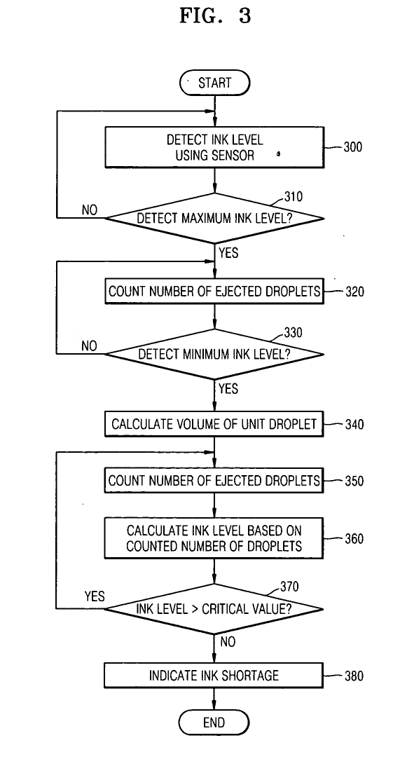

FIG. 3 is a flowchart illustrating a method of detecting an ink level according to an embodiment of the present general inventive concept.

Referring to FIGS. 2 and 3, a volume of ink stored in the ink storage unit 200 of the image forming apparatus is detected using a sensor (operation 300). The sensor may be an optical sensor that senses the ink level based on the amount of reflected light when light is radiated onto the ink, a weight sensor that senses the ink level by measuring its weight, and a magnetic sensor that senses the ink level using a magnetic field.

It is determined whether the ink level detected in operation 300 corresponds to a predetermined maximum ink level (operation 310).

In operation 310, if it is determined that the ink level detected in operation 300 does not correspond to the maximum ink level, the ink level volume stored in the ink storage unit 200 in operation 300 is detected by the sensor (operation 300).

In operation 310, if it is determined that the ink level detected in operation 300 corresponds to the maximum ink level, the number of ink droplets ejected after the maximum ink level is detected in operation 310 is counted (operation 320). The number of ejected ink droplets is the total number of dots dispersed through all nozzles included in the image forming apparatus.

After operation 320, it is determined whether the ink level of the ink storage unit 200 corresponds to a predetermined minimum ink level, using the sensor (operation 330).

In operation 330, if it is determined that the stored ink level does not correspond to the minimum ink level, the counting of the number of ejected ink droplets in operation 320 continues.

In operation 330, if it is determined that the stored ink level corresponds to the minimum ink level, the counting of the number of ejected ink droplets stops, and the total number of ink droplets counted in operation 320 is used to calculate a volume of unit ink droplet ejected from a unit nozzle included in the image forming apparatus by the following mathematical expression 3 (operation 340):
Volₚₑᵣ=(Vol_{high}−Vol_{low})/Num 3,

where Volₚₑᵣ denotes the volume of the unit ink droplet ejected from the one or more unit nozzles, Vol_{high} denotes the maximum ink level, Vol_{low} denotes the minimum ink level, and Num denotes the number of droplets counted in operation 320. In operation 340, the calculated volume of the unit droplet is stored in a storage medium, such as a memory or a hard disk drive (HDD).

After operation 340, the number of droplets ejected from all the nozzles of the image forming apparatus after the minimum ink level is detected in operation 330 is counted (operation 350).

By using the volume per ink droplet calculated in operation 340 and the number of ink droplets counted in operation 350, the ink level of the ink storage unit 200 is calculated using the following mathematical expression 4 (operation 360):
Volᵢₙₖ=Vol_{low}−(Volₚₑᵣ*Num_{low}) 4,

where Volᵢₙₖ denotes the ink level of the ink storage unit 200, Vol_{low} denotes the minimum ink level, Volₚₑᵣ denotes the volume of the unit ink droplet calculated in operation 340, and Num_{low} denotes the number of droplets counted in operation 350.

The ink level calculated in operation 360 is compared with a predetermined critical value (operation 370). The critical value is an ink level at which printing is impaired due to an insufficient volume of ink.

In operation 370, if it is determined that the ink level calculated in operation 360 is greater than the critical value, the counting of the number of ink droplets ejected from the nozzles in operation 350 continues.

In operation 370, if it is determined that the ink level volume calculated in operation 360 is less than the critical value, the ink shortage display unit (e.g., an LCD panel provided in the image forming apparatus or a dialog box on a host device) indicates that the ink storage unit 200 is empty (operation 380).

A user can then replace the empty ink storage unit 200 with a new ink storage unit containing ink. Alternatively, the user can refill the empty ink storage unit 200 to a level between the maximum ink level and the minimum ink level, or to a level greater than the maximum ink level.

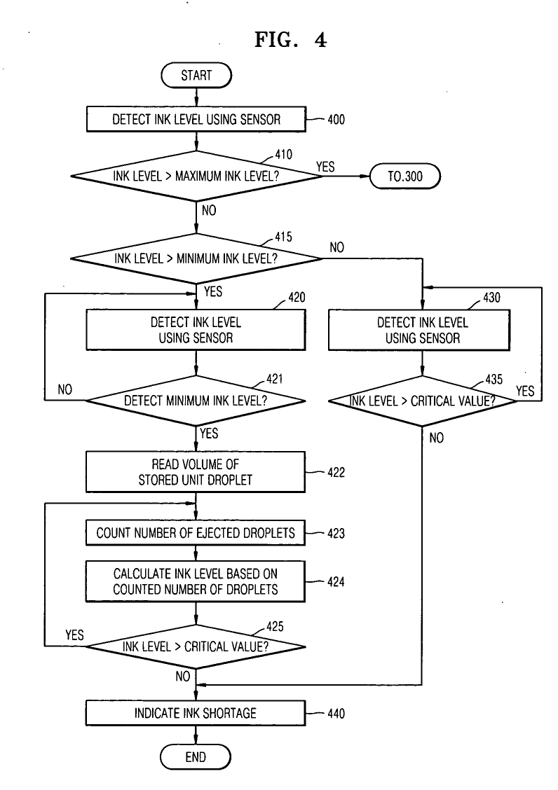

FIG. 4 is a flowchart illustrating a method of detecting an ink level volume according to another embodiment of the present general inventive concept.

According to this embodiment, the ink level can be detected when an ink storage unit (such as the ink storage unit 200 of FIG. 2 or an ink cartridge) is refilled with ink without replacing the ink storage unit (such as the ink storage unit 200 of FIG. 2 or the ink cartridge).

Referring to FIGS. 2-4, the ink level of the ink storage unit 200 of an image forming apparatus is detected using a sensor (operation 400).

The ink level detected in operation 400 is compared with a maximum ink level (operation 410).

In operation 410, if it is determined that the ink level detected in operation 400 is greater than the maximum ink level, then the method can proceed to operation 300 illustrated in FIG. 3.

In operation 410, if it is determined that the ink level detected in operation 400 is less than the maximum ink level, the ink level detected in operation 400 is compared with a minimum ink level (operation 415).

In operation 415, if it is determined that the ink level detected in operation 400 is greater than the minimum ink level, the ink level of the ink storage unit 200 is detected using the sensor (operation 420).

In operation 415, if it is determined that the ink level detected in operation 400 is less than the minimum ink level, the ink level of the ink storage unit 200 is detected using a sensor (operation 430). The ink level detected in operation 430 is compared with a predetermined critical value (operation 435). The critical value is an ink volume at which printing is impaired due to an insufficient volume of ink. In operation 435, if the ink level detected in operation 430 is greater than the critical value, the ink volume in the ink storage unit 200 is detected using the sensor in operation 430 (operation 430). In operation 435, if the ink level detected in operation 430 is less than the critical value, the ink shortage display unit (e.g., an LCD panel provided in the image forming apparatus or dialog box on a host device) indicates that the ink storage unit 200 is empty (operation 440).

After operation 420, it is determined whether the ink level detected in operation 420 corresponds to the minimum ink level (operation 421).

In operation 421, if it is determined that the detected ink level does not correspond to the minimum ink level, the ink volume in the ink storage unit 200 is detected by the sensor (operation 420).

In operation 421, if it is determined that the ink level detected in operation 420 corresponds to the minimum ink level, the volume of the unit ink droplet stored in operation 340 illustrated in FIG. 3 is read (operation 422).

After operation 422, the number of droplets ejected from nozzles of the image forming apparatus after the minimum ink level is detected in operation 421 is counted (operation 423).

Based on the number of droplets counted in operation 423, and the volume of the unit ink droplet read in operation 422, the ink level of the ink storage unit 200 is calculated using the following mathematical expression 5 (operation 424):
Volᵢₙₖ=Vol_{low}−(Volₚₑᵣ*Num_{low}) 5,

where Volᵢₙₖ denotes the ink level of the ink storage unit 200, Vol_{low} denotes the minimum ink level, Volₚₑᵣ denotes the volume of the unit ink droplet read in operation 422, and Num_{low} denotes the number of droplets counted in operation 423.

The ink level calculated in operation 424 is compared with the predetermined critical value (operation 425).

In operation 425, if the ink level calculated in operation 424 is greater than the critical value, the counting of the number of ink droplets ejected from the nozzles in operation 423 is continued.

In operation 425, if the ink level detected in operation 424 is less than the critical value, the ink shortage display unit 250 (e.g., an LCD panel provided in the image forming apparatus or dialog box provided on a host device) indicates that the ink storage unit 200 is empty (operation 440).

Accordingly, in a method and apparatus of detecting an ink level according to the present general inventive concept, a sensor to detect an ink level is used together with a count of a number of ejected ink droplets to detect the level (e.g., volume) of stored ink. The sensor detects the ink level in a range between a maximum ink level and a minimum ink level, and an ink margin is not needed to allow for variations caused by temperature. As a result, unnecessary ink consumption can be reduced, and the ink level can be detected even after an ink storage unit is refilled.

In addition, in order to detect ink levels below the minimum ink level, a volume of ejected unit ink droplet is calculated to be between the maximum ink level and the minimum ink level and the number of ejected ink droplets is counted, so that the ink level can be accurately calculated even after temperature variations and at very low ink levels.

Various embodiments of the present general inventive concept can be embodied as computer readable codes on a computer readable recording medium. The computer can include any device having information processing capabilities. The computer readable recording medium can be any data storage device that can store data that can be thereafter read by a computer system. Examples of the computer readable recording medium include read-only memory (ROM), random-access memory (RAM), CD-ROMS, magnetic tapes, floppy disks, and optical data storage devices, and carrier waves (such as data transmission through the Internet). The computer readable recording medium can also be distributed over network coupled computer systems so that the computer readable code is stored and executed in a distributed fashion. Various embodiments of the present general inventive concept may also be embodied in hardware or in a combination of hardware and software.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to detect an ink volume in an image forming apparatus, comprising:
an ink storage unit to store ink;
an ink level detection unit to detect an ink level of the ink of the ink storage unit using a sensor and to output the detected result;
a calculation unit to calculate a volume of an ejected unit ink droplet in a predetermined ink volume range using the result output from the ink level detection unit; and
an ink level computation unit to compute an ink volume remaining in the ink storage unit using the calculated volume of the ejected unit ink droplet.

2. The apparatus according to claim 1, wherein the ink level detection unit detects the ink level of the ink storage unit when the ink level corresponds to a predetermined maximum ink level or a predetermined minimum ink level and outputs the detected result.

3. The apparatus according to claim 2, wherein the calculation unit comprises:
a counting unit to count the number of ejected ink droplets in the predetermined ink volume range between the maximum ink level and the minimum ink level in response to the result output from the ink level detection unit; and
a unit droplet level calculation unit to calculate the volume of the ejected unit ink droplet using the count number.

4. The apparatus according to claim 3, wherein the unit droplet level calculation unit calculates the volume of the ejected unit ink droplet using the following mathematical expression:
Volₚₑᵣ=(Vol_{high}−Vol_{low})/Num
where Volₚₑᵣ denotes the volume of the ejected unit ink droplet, Vol_{high} denotes the maximum ink level, Vol_{low} denotes the minimum ink level, and Num denotes the number of ink droplets counted by the counting unit of the calculation unit.

5. The apparatus according to claim 2, wherein the ink level computation unit comprises:
a counting unit to count the number of droplets ejected after the minimum ink level is detected; and
an ink level calculation unit to calculate the ink volume of the ink storage unit based on the number of counted ink droplets using the calculated volume of the ejected unit ink droplet.

6. The apparatus according to claim 5, wherein the ink level calculation unit calculates the ink volume of the ink storage unit using the following mathematical expression:
Volᵢₙₖ=Vol_{low}−(Volₚₑᵣ*Num_{low})
where Volᵢₙₖ denotes the ink level of the ink storage unit, Vol_{low} denotes the minimum ink level, Volₚₑᵣ denotes the volume of the ejected unit ink droplet, and Num_{low} denotes the number of ink droplets counted by the counting unit of the ink level computation unit.

7. The apparatus according to claim 2, wherein the ink level detection unit determines the minimum ink level to be 5% of the maximum amount of ink that can be stored in the ink storage unit.

8. The apparatus according to claim 2, further comprising:
a unit droplet level storage unit to store the volume of the ejected unit ink droplet calculated by the calculation unit.

9. The apparatus according to claim 2, wherein the calculation unit updates the volume of the ejected unit ink droplet in a second predetermined ink volume range between the maximum ink level and the minimum ink level when the ink storage unit is refilled with ink to a level greater than the maximum ink level.

10. The apparatus according to claim 8, wherein the ink level computation unit reads the volume of the unit ink droplet stored in the unit droplet level storage unit after the minimum ink level is detected and computes the ink level of the ink storage unit using the read volume of the unit ink droplet.

11. The apparatus according to claim 6, further comprising:
an ink shortage display unit to indicate that the ink storage unit is empty when the calculated ink level is less than a predetermined critical value.

12. A method of detecting an ink volume in an image forming apparatus, the method comprising:
detecting an ink level of an ink storage unit using a sensor;
calculating a volume of an ejected unit ink droplet in a predetermined range of the ink level using the detected result; and
computing an ink volume of the ink storage unit using the calculated volume of the ejected unit ink droplet.

13. The method according to claim 12, wherein the detecting of the ink level of the ink storage unit comprises detecting a minimum ink level when a remaining amount of ink is 5% of a maximum amount of ink that can be stored in the ink storage unit.

14. The method according to claim 12, further comprising:
storing the calculated volume of the ejected unit ink droplet.

15. The method according to claim 12, wherein the calculating of the volume of an ejected unit ink droplet comprises updating the volume of the ejected unit ink droplet in a second predetermined volume range between a maximum ink level and a minimum ink level when the ink storage unit is refilled with ink to a level greater than the maximum ink level.

16. The method according to claim 14, wherein the computing of the ink volume of the ink storage unit comprises:
reading the volume of the ejected unit ink droplet stored in the unit droplet level storage unit and computing the ink volume of the ink storage unit using the read volume of the ejected unit ink droplet.

17. The method according to claim 12, further comprising:
indicating that the ink storage unit is empty when the computed ink volume is less than a predetermined critical value.

18. A computer-readable medium having embodied thereon a computer program for performing a method of detecting an ink volume in an image forming apparatus, the method comprising:
detecting an ink level of an ink storage unit using a sensor;
calculating a volume of an ejected unit ink droplet in a predetermined range of the ink level using the detected result; and
computing an ink volume of the ink storage unit using the calculated volume of the ejected unit ink droplet.

19. An apparatus to determine an ink level of an image forming apparatus, the apparatus comprising:
an ink level detecting unit to detect a first amount of ink contained in an ink storage unit; and
a unit to calculate a second amount of ink remaining in the ink storage unit using a first number of ink droplets consumed from the first amount of ink and a second number of ink droplets consumed after the first amount of in has been consumed.

20. The apparatus according to claim 19, wherein:
the first amount of ink comprises an amount of ink between a first level and a second level of the ink; and
the second amount comprises an amount of ink less than the second level of ink.

21. The apparatus according to claim 19, wherein the unit comprises:
a calculation unit to generate a volume of the unit ink droplet according to the detected amount and the first number of ink droplets consumed from the detected amount; and
an ink level computation unit to generate the second amount of ink according to the second number of ink droplets.

22. The apparatus according to claim 19, wherein:
the ink level detecting unit detects a third amount of ink which is refilled in the ink storage unit after at least a portion of the first amount corresponding to the first number of ink droplets and a second amount corresponding to the second number of ink droplets has been consumed; and
the unit calculates a fourth amount of ink remaining in the ink storage unit using a third number of ink droplets consumed from the third amount of ink and a fourth number of ink droplets consumed after the third amount of ink has been consumed.

23. An apparatus to detect an ink level of an ink storage unit of an image forming apparatus, the apparatus comprising:
an ink level detecting unit to detect a first level and a second level of ink; and
a unit to generate a volume of a unit ink droplet according to a first number of ink droplets and a first amount of the ink between the first level and the second level, and to generate a second amount of ink consumed when the ink is lower than the second level using the volume of the unit ink droplet and a second number of ink droplets consumed from the second amount of ink.

24. The apparatus according to claim 23, wherein:
the unit generates a third amount of ink remaining in the ink storage unit using the first amount and the second amount.
